(19) United States
(12) Patent Application Publication
(10) Pub. No.: US 2010/0252021 A1
(43) Pub. Date: Oct. 7, 2010

(54) GRILLING APPARATUS

(75) Inventors: Donald Bryce, Framingham, MA (US); Felix Wong, Ashland, MA (US); Paul Santarsiero, Avon, CT (US)

Correspondence Address: FRANCIS EDWARD MARINO, 394 MEREDITH NECK ROAD, MEREDITH, NH, 03253, US

(73) Assignee: Jordan Kahn Company, Newton, MA (US)

(21) Appl. No.: 12/751,165

(22) Filed: Mar. 31, 2010

Related U.S. Application Data
(60) Provisional application No. 61/167,242, filed on Apr. 7, 2009.

(51) Int. Cl. A47J 37/00

(52) U.S. Cl. 126/25 R; 126/1 R

(57) ABSTRACT

Disclosed is a grill having a firebox with an open upper end upon which rests a cooking grate. A burning chamber is disposed within the firebox and below the open upper end for containing a burning fuel material. A lid is hingedly affixed to the firebox and liftable to access either the grate or the burning chamber. A capture mechanism enables the lid to engage the grate such that when the capture mechanism is in a disengagement condition the lid may be lifted independently of the grate to access the grate, and when the capture mechanism is in an engagement condition lifting of the lid causes simultaneous lifting of the grate off of the firebox to allow access to the burning chamber.

### RELATED APPLICATION

This application is a Continuation of and claims the benefit of pending U.S. Provisional Application Ser. No. 61/167,242, filed Apr. 7, 2009, the entire teachings of which are incorporated herein by reference.

### FIELD OF THE INVENTION

The present invention is related to grilling of food. More specifically, this invention is related to a charcoal grilling apparatus having improved means for adding and replacing charcoal and smoking chips therein, improved means for controlling the grilling temperature and air exchange within the firebox, and other new features.

### BACKGROUND

Charcoal grills for outdoor cooking are well known, but include numerous drawbacks and disadvantages, including failures of convenience and function. Existing grills have proven to be either difficult to use, complicated and prone to failure, ineffective, or some combination of these failings.

There exists a need for improvement in the function and convenience of charcoal grilling, and such is an object of the present invention. There exists a need for a grill that allows for less complicated and cumbersome installation and replacement of charcoal, and such is an object of the present invention. There exists a need for a grill that allows for easier access to the charcoal burning area, and such is an object of the present invention. There exists a need for a grill that allows for hands-free opening and closing of the charcoal burning area, and such is an object of the present invention. There exists the need for a charcoal grill with improved temperature and air exchange control, and such is an object of the invention.

Further needs and objects exist which are addressed by the present invention, as may become apparent upon review of the included disclosure of exemplary embodiments thereof.

### SUMMARY OF THE INVENTION

The invention may be practiced in a charcoal or wood burning grill having a firebox for holding and burning the charcoal or wood, which firebox is covered by a perforated cooking grate. A lid covers the firebox and is hingedly pivotable relative thereto to access both the cooking grate and the charcoal/wood burning area of the firebox. The cooking grate is movably attached to the firebox by linkage such as a parallelogram linkage arrangement, so that the grate may be lifted while remaining in a horizontal disposition to access the charcoal holding area for the addition of charcoal or removal of ashes. By maintaining its horizontal disposition, the grate may be lifted even while food is thereupon, such as when additional charcoal is required during cooking, without causing the roll or slide there-from.

The lid is selectably connectable to the grate such that it may lift the grate from the firebox as the lid is opened, or so that it may alternatively leave the grate atop the firebox to access food cooking on the grate. As disclosed in the exemplary embodiments a capture mechanism includes pair of actuators, one on each side of the lid, each movable from an engaged to a disengaged state. In the engaged state, a pair of grate latch arms are moved by the actuators to engage hooks of the grate. In the disengaged state, the hooks are free of the latch arms.

A novel venting arrangement allows convenient adjustment of the airflow into and out of the firebox. When the charcoal is initially lit, it requires a reasonable supply of fresh air to become fully ignited. It is then preferable to fully ventilate the firebox. By opening the vent above, a supply of fresh oxygen-rich air is allowed to enter from openings on the underside of the firebox. Once the charcoal is fully ignited, it is preferable to accelerate the heating up of the firebox to the desired cooking temperature. It is then preferable to minimize ventilation to increase the speed at which the firebox comes up to temperature. Once the desired temperature is reached and cooking is initiated, it is desired to optimize the ventilation to balance the influx of fresh air to feed burning with the exhaustion of excessive heat and fumes. Such excessive heat and fumes rising within the firebox are found to be most effectively removed by venting at the peak of the lid.

In an exemplary embodiment, the invention is practiced in a grill comprising a firebox having a shell with an open upper end and a burning chamber within the shell below the open upper end and in which a fuel is burned. A cooking grate has a cooking position covering the burning chamber and resting on the open upper end and a loading position exposing the open end and the burning chamber. A lid is hingedly affixed to the firebox and pivotable relative thereto between a closed position wherein the lid denies access to the grate and the burning chamber and an open position. A capture mechanism is convertible between an engagement condition and a disengagement condition.

When in the engagement condition the capture mechanism engages the lid to the grate, and when in the disengagement condition the capture mechanism does not engage the lid to the grate. When the lid is not engaged to the grate by the capture mechanism and the lid is pivoted from the closed position to the open position, access to the grate is enabled, and when the lid is engaged to the grate by the capture mechanism and the lid is pivoted from the closed position to the open position, the grate is simultaneously moved from the cooking position to the loading position and access to the burning chamber is enabled.

The grill may include a latch actuator to selectively move the capture mechanism between the engagement and disengagement conditions. The latch actuator is preferably disposed externally of the grill. The capture mechanism may include a latch arm and a hook, wherein one of the lid and the grate includes the latch arm, and the other of the lid and the grate includes the hook. The latch arm may be connected to and movable with the latch actuator, and the one of the lid and the grate may include the latch actuator. Preferably, the lid comprises the latch arm and the latch actuator and the grate comprises the hook.

The capture mechanism may be biased towards the disengagement condition and may automatically convert thereto as the lid is closed with the capture mechanism in the engagement condition. A link may connect the grate to the firebox and a pivotable connection of the grate to the lid may be provided at the capture mechanism, the link and the pivotable connection cooperating to cause the grate to maintain a substantially horizontal disposition during movement between the cooking and loading positions so that food will not fall off the grate.

The invention may also be practiced in a barbeque grill having a burning chamber, a cooking grate having a cooking position covering the burning chamber and resting thereon and a loading position exposing the burning chamber, a lid affixed to the burning chamber and movable relative thereto between a closed position and an open position, and a capture mechanism convertible between an engagement condition and a disengagement condition. When the lid is in the closed position, access to the grate and the burning chamber is denied. When the lid is moved from the closed position to the open position with the capture mechanism in the disengagement condition, access to the grate is enabled. And when the lid is moved from the closed position to the open position with the capture mechanism in the engagement condition, the grate is moved by the capture mechanism from the cooking position to the loading position and access to the burning chamber is enabled.

The invention may also be practiced in a barbeque grill having a firebox with a burning chamber and an open upper end, the open upper end including a rear edge, a cooking grate having left and right side edges and movable between a cooking position covering the burning chamber and resting on the open upper end and a loading position displaced from the open upper end to expose the burning chamber, and a lid hingedly affixed to the firebox at the rear edge and movable relative thereto between a closed position and an open position. The lid has left and right sides. A left hook is rigidly affixed to the grate adjacent the left edge and a right hook is rigidly affixed to the grate adjacent the right edge. A left latch arm is affixed to and within the lid at the left side and movable relative thereto for engaging to or disengaging from the left hook, and a right latch arm is affixed to and within the lid at the right side and movable relative thereto for engaging to or disengaging from the right hook. When the lid is in the closed position, access to the grate and the burning chamber is denied. When the lid is moved from the closed position to the open position with the left and right arms engaged to the left and right hooks, respectively, access to the grate is enabled. And when the lid is moved from the closed position to the open position with the left and right arms disengaged from the left and right hooks, respectively, the grate is moved by the lid from the cooking position to the loading position and access to the burning chamber is enabled.

The grill may have left and right latch actuators accessible externally of the grill, the latch actuators communicating with the left and right latch arms, respectively, and movable for causing the engagement of and disengagement from the left and right hooks, respectively. The grill may also have left and right links connecting the grate to the firebox and left and right pivotable connections of the grate to the lid at the left and right hooks, respectively, the left and right links and the left and right pivotable connections cooperating, respectively, to cause the grate to maintain a substantially horizontal disposition during movement between the cooking and loading positions.

Further features and aspects of the invention are disclosed with more specificity in the Detailed Description and accompanying drawings of an exemplary embodiment provided herein.

### BRIEF DESCRIPTION OF THE DRAWINGS

Many aspects of the invention can be better understood with reference to the included Drawings showing a representative embodiment for practicing the invention which corresponds to the accompanying Detailed Description. The components in the Drawings are not necessarily to scale, emphasis instead being placed upon clearly illustrating the principles of the invention. Moreover, like reference numerals in the Drawings designate corresponding parts throughout the several views.

FIG. 1 is a perspective view of an exemplary embodiment for practicing the invention in the form of a stand-alone barbeque grill having its lid closed;

FIG. 2 is a front view of the grill of FIG. 1;

FIG. 3 is a top view of the grill of FIG. 1;

FIG. 4 is a perspective view of the grill of FIG. 1 having the lid opened while the capture mechanism is in its engaged state;

FIG. 5 is a perspective view of the grill of FIG. 1 having the lid opened while the capture mechanism is in its disengaged state;

FIG. 6 is a side view of the grill of FIG. 1 showing the movement of the lid and the cooking grate while the capture mechanism is in its engaged state;

FIG. 7 is a close-up partial perspective view of the capture mechanism of the grill of FIG. 1 in the engagement condition;

FIG. 8 is a close-up partial side view of the capture mechanism of the grill of FIG. 1 in the engagement condition with the lid closed;

FIG. 9 is a close-up partial side view of the capture mechanism of the grill of FIG. 1 in the engagement condition with the lid opened;

FIG. 10 is a close-up partial side view of the capture mechanism of the grill of FIG. 1 with the latch-arm moving from the engagement condition to the disengagement condition;

FIG. 11 is a side view of the grill of FIG. 1 showing its ventilation flow;

FIG. 12 is a partial top view of the venting mechanism of the grill of FIG. 1; and

FIG. 13 is a cross-sectional top view of the intake-venting ash cup of the grill of FIG. 1.

### DETAILED DESCRIPTION OF AN EXEMPLARY EMBODIMENT

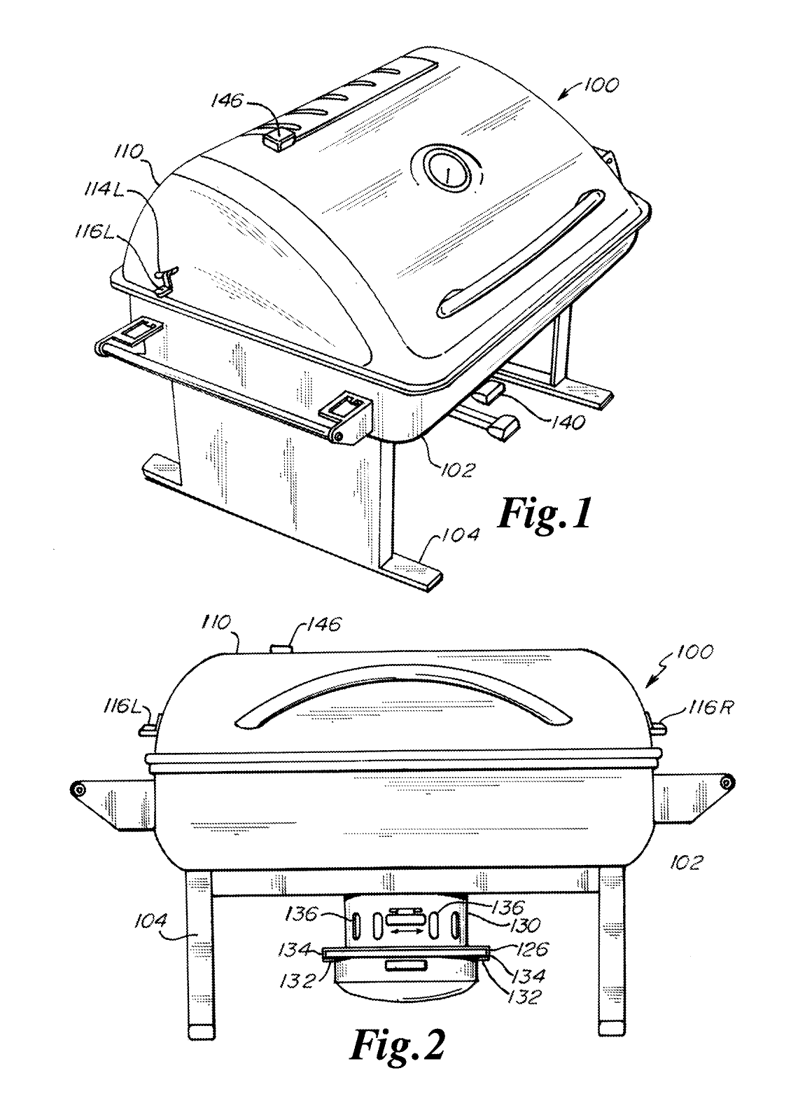

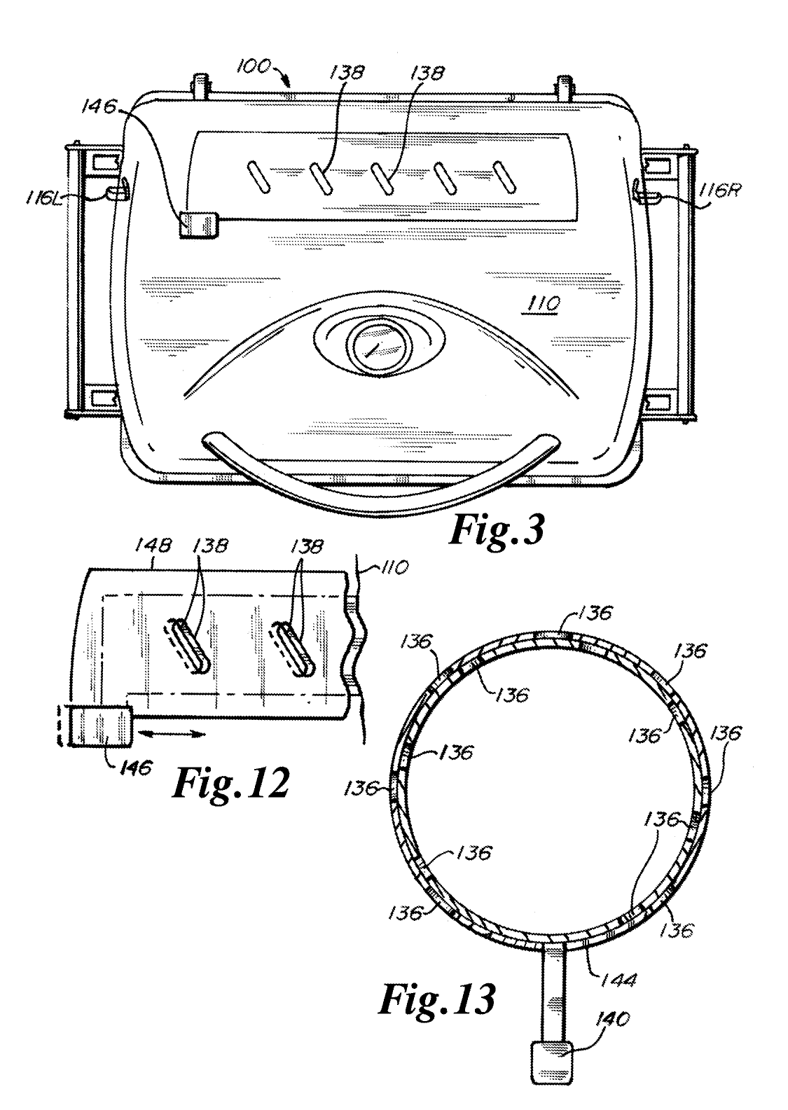

An exemplary barbeque grill 100 for practicing the invention is shown FIGS. 1-13. The grill includes firebox 102 for holding burning charcoal 200. The firebox rests on stand 104 to support the sometimes-hot firebox off of a support surface such as the floor or a tabletop. The firebox has an open upper end upon which typically rests cooking grate 106. Within the firebox is burning chamber 108 in which the charcoal burns to create heat which rises to cook food 202 resting atop the grate. Lid 110 is hingedly affixed to the firebox and is liftable to access the grate and the burning chamber.

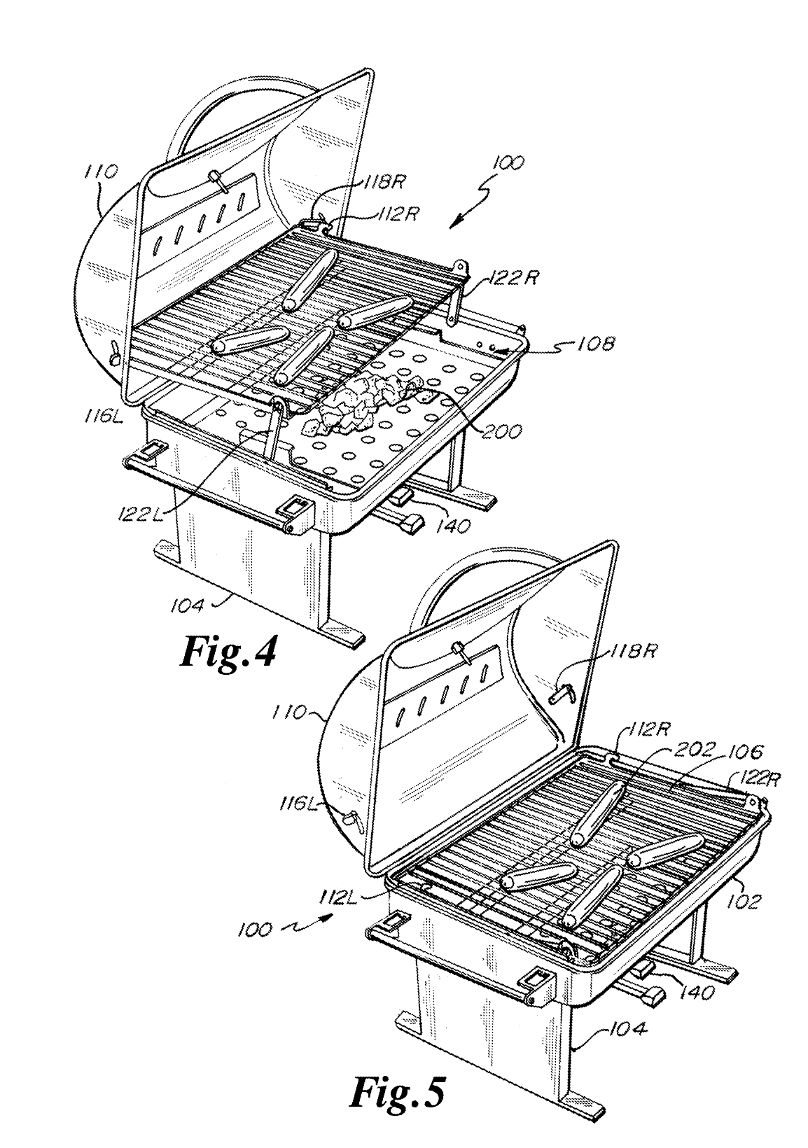

Referring to FIGS. 4 through 10, the grate includes a pair of hooks, 112L and 112R, each disposed on an opposite side edge of the grate. A capture mechanism on each side, 114L and 114R, includes those hooks, a pair of latch actuators, 116L and 116R, one on each side of the lid and accessible from the outside thereof, and latch arms 118L and 118R, is provided for selectively engaging the lid and grate.

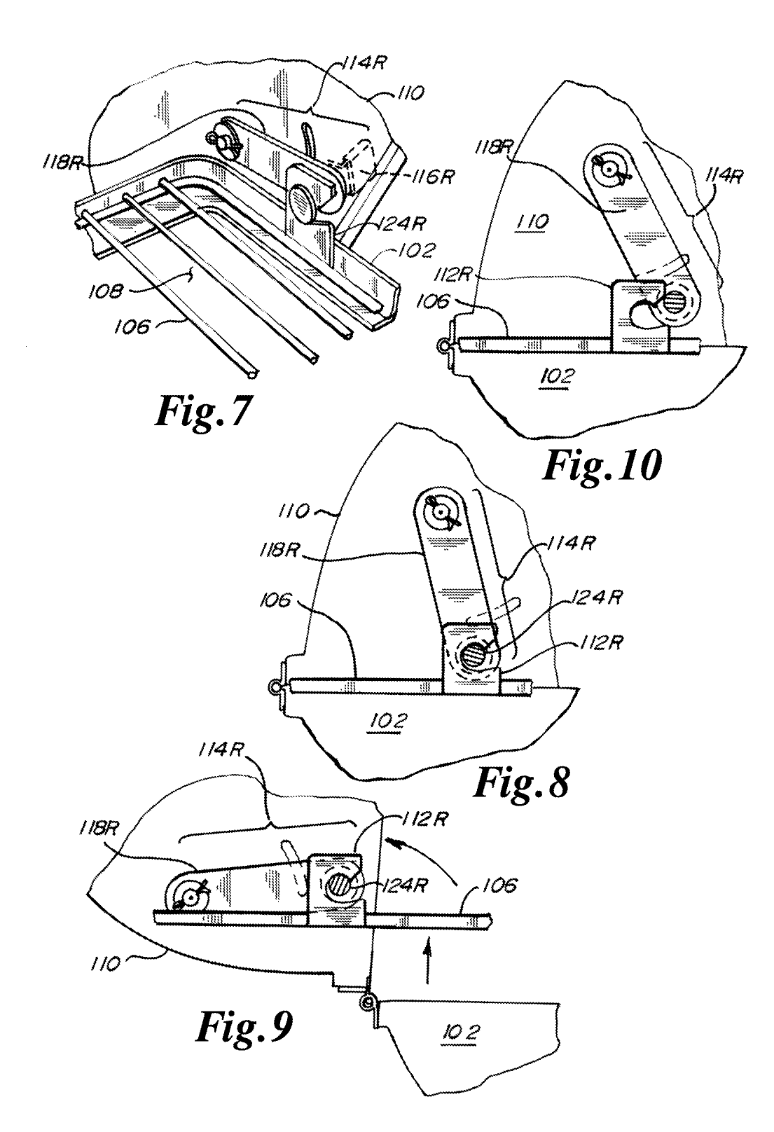

The latch arms are each disposed within the interior of the lid and adjacent an associated one of the hooks when the lid is it its closed position of FIGS. 1, 2, 3, 8, and 10. The latch arms are each connected to an adjacent actuator and movable therewith so that each latch arm can be moved by movement of the associated actuator between the engagement condition best seen in FIGS. 7 to 9, wherein the latch arm engages the adjacent grate hook, and the disengagement condition, best seen in FIG. 10, wherein the latch arm is disengaged from the adjacent grate hook.

When the latch arms are in their disengagement conditions, the lid may be lifted independently of the grate, as seen in FIG. 4, to access the food cooking atop the grate. When the latch arms are in their engagement conditions, lifting of the lid causes simultaneous lifting of the grate off of the firebox, as seen in FIG. 5, to allow access to the burning chamber, such as for replacing charcoal or adding smoking chips.

The capture mechanism may be biased towards the disengagement condition, such as by a spring (not shown) engaging both latch arms, to automatically cause the latch arms to return to the disengagement condition as the lid is closed after having been in the engagement condition. In this way, one would move the normally-disengaged latch controls to the engagement condition when access to the burning chamber is desired, lift the lid and grate to access the burning chamber, drop the lid back down to cover the firebox and automatically reset the capture mechanism back to the disengagement condition. Then the next time the lid is opened without actuating the latch control, the lid would not lift the grate unless the capture mechanism was again engaged.

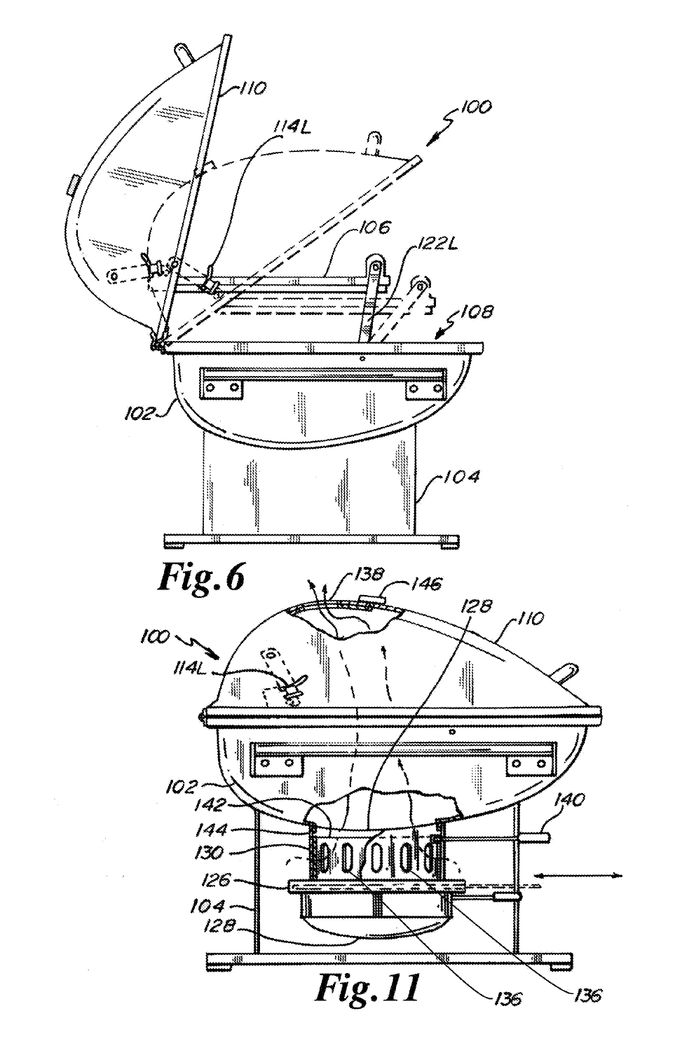

A parallelogram linkage mechanism including a pair of grate links 122L and 122R and a pair of grate supporting pivots 124L and 124R at the engagement mechanism causes the grate to maintain a horizontal disposition during lifting, as seen in FIG. 6, so that food resting atop the grill is undisturbed when the grate is lifted, such as to add charcoal or smoking chips during cooking.

A vented ash-collecting cup assembly 126 is removable fixed to the underside of the firebox and arranged to both receive spent charcoal ashes through hole 128 at the bottom of the firebox and to provide air to the burning chamber. As seen in FIGS. 11 and 13, the cup assembly includes ash cup 128 and vent tube 130. The ash cup includes a flange 132 slidingly received with a pair of grooves 134 of the vent tube so that the ash cup may be slid from the vent tube for ash disposal.

The vent system is provided including intake vents 136 of the vent tube and exhaust vents 138 disposed at the top of the lid. Both the intake and exhaust vents are adjustable to control venting flow through the burning chamber according to the process or style of cooking.

Referring to FIGS. 2 and 13, the intake vents may be closed or opened to any continually varying degree by rotation if intake vent actuator 140 to cause inner vent tube 142 to rotate relative to outer vent tube 144. Because intake vents 136 pass identically through both the inner and outer tubes, the relative rotational repositioning of the tubes changes the effective orifice size of the intake vents accordingly.

Referring to FIG. 12, the exhaust vents may also be closed or opened to any continually varying degree by sliding exhaust vent actuator 146 to cause vent shutter 148 to slide relative to the lid. Because exhaust vents 138 pass identically through both the shutter and lid, the relative translational repositioning of the shutter and lid changes the effective orifice size of the exhaust vents accordingly.

When the charcoal is initially lit, both the intake and exhaust vents may preferably be fully opened to allow fresh air into the burning chamber. Heated air from the ignition rises and escapes through the opened exhaust vents and draws a supply of fresh oxygen-rich air in through the opened intake vents to accelerate combustion. Once the charcoal is fully ignited the exhaust vents are moved towards a more closed position to reduce the escape of heat and accelerate heating up of the firebox to the desired cooking temperature. Once the desired temperature is reached and cooking is initiated, the style of heating may dictate various modes of ventilation. Meat-smoking typically requires cooking at lower temperatures with reduced ventilation to hold smoke within the chamber. For vegetables and other food items that are better cooked for shorter times at higher temperatures the vents can be more opened. The placement of the intake vents at the bottom of the fire box and the exhaust vents at the peak of the lid, together with the cooperative adjustability allowed by the disclosed embodiment are found to provide optimal control of cooking conditions by the user.

Various changes in form and detail may be made without departing from the spirit and scope of the invention, so the invention should therefore only be considered according to the following claims, including all equivalent interpretation to which they are entitled.

We claim:

1. A grill comprising:
a firebox comprising;
a shell having an open upper end; and
a burning chamber within said shell below said open upper end and in which a fuel is burned;
a cooking grate having a cooking position covering said burning chamber and resting on said open upper end and a loading position exposing said open end and said burning chamber;
a lid hingedly affixed to said firebox and pivotable relative thereto between
a closed position wherein said lid denies access to said grate and said burning chamber; and
an open position;
a capture mechanism convertible between an engagement condition and a disengagement condition; wherein
when in said engagement condition said capture mechanism engages said lid to said grate; and
when in said disengagement condition said capture mechanism does not engage said lid to said grate, and wherein
when said lid is not engaged to said grate by said capture mechanism and said lid is pivoted from said closed position to said open position, access to said grate is enabled; and
when said lid is engaged to said grate by said capture mechanism and said lid is pivoted from said closed position to said open position, said grate is simultaneously moved from said cooking position to said loading position and access to said burning chamber is enabled.

2. The grill of claim 1 further comprising a latch actuator to selectively move said capture mechanism between said engagement and disengagement conditions.

3. The grill of claim 2 wherein said latch actuator is disposed externally of said grill.

4. The grill of claim 3 wherein said capture mechanism further comprises a latch arm and a hook, and wherein one of said lid and said grate comprises said latch arm, and the other of said lid and said grate comprises said hook.

5. The grill of claim 4 wherein said latch arm is connected to and movable with said latch actuator, and said one of said lid and said grate comprises said latch actuator.

6. The grill of claim 4 wherein said lid comprises said latch arm and said grate comprises said hook.

7. The grill of claim 6 wherein said lid comprises said latch actuator.

8. The grill of claim 7 wherein said capture mechanism is biased towards said disengagement condition and automatically converts thereto as said lid is closed with said capture mechanism in said engagement condition.

9. The grill of claim 7 further comprising a link connecting said grate to said firebox and a pivotable connection of said grate to said lid at said capture mechanism, said link and said pivotable connection cooperating to cause said grate to maintain a substantially horizontal disposition during movement between said cooking and loading positions.

10. The grill of claim 1 further comprising linkage connecting said grate to said firebox and said lid, said linkage adapted to cause said grate to maintain a substantially horizontal disposition during movement between said cooking and loading positions.

11. A barbeque grill comprising:
a burning chamber;
a cooking grate having a cooking position covering said burning chamber and resting thereon and a loading position exposing said burning chamber;
a lid affixed to said burning chamber and movable relative thereto between a closed position and an open position;
a capture mechanism convertible between an engagement condition and a disengagement condition; wherein
when said lid is in said closed position, access to said grate and said burning chamber is denied;
when said lid is moved from said closed position to said open position with said capture mechanism in said disengagement condition, access to said grate is enabled; and
when said lid is moved from said closed position to said open position with said capture mechanism in said engagement condition, said grate is moved by said capture mechanism from said cooking position to said loading position and access to said burning chamber is enabled.

12. The grill of claim 11 further comprising a latch actuator disposed externally of said grill and movable to selectively convert said capture mechanism between said engagement and disengagement conditions.

13. The grill of claim 12 wherein said capture mechanism further comprises a latch arm and a hook, and wherein said lid comprises said latch arm, and said grate comprises said hook.

14. The grill of claim 13 wherein said latch arm is connected to and movable with said latch actuator, and said lid comprises said latch actuator.

15. The grill of claim 14 wherein said capture mechanism is biased towards said disengagement condition and automatically converts thereto as said lid is closed with said capture mechanism in said engagement condition.

16. The grill of claim 15 further comprising a link connecting said grate to said burning chamber and a pivotable connection of said grate to said lid at said capture mechanism, said link and said pivotable connection cooperating to cause said grate to maintain a substantially horizontal disposition during movement between said cooking and loading positions.

17. The grill of claim 11 further comprising linkage connecting said grate to said burning chamber and said lid, said linkage adapted to cause said grate to maintain a substantially horizontal disposition during movement between said cooking and loading positions.

18. A barbeque grill comprising:
a firebox comprising a burning chamber and an open upper end, said open upper end comprising a rear edge;
a cooking grate having left and right side edges and movable between a cooking position covering said burning chamber and resting on said open upper end and a loading position displaced from said open upper end to expose said burning chamber;
a lid hingedly affixed to said firebox at said rear edge and movable relative thereto between a closed position and an open position, said lid comprising left and right sides;
a left hook rigidly affixed to said grate adjacent said left edge;
a right hook rigidly affixed to said grate adjacent said right edge;
a left latch arm affixed to and within said lid at said left side and movable relative thereto for engaging to or disengaging from said left hook;
a right latch arm affixed to and within said lid at said right side and movable relative thereto for engaging to or disengaging from said right hook; wherein
when said lid is in said closed position, access to said grate and said burning chamber is denied;
when said lid is moved from said closed position to said open position with said left and right arms engaged to said left and right hooks, respectively, access to said grate is enabled; and
when said lid is moved from said closed position to said open position with said left and right arms disengaged from said left and right hooks, respectively, said grate is moved by said lid from said cooking position to said loading position and access to said burning chamber is enabled.

19. The barbeque grill of claim 18 further comprising left and right latch actuators accessible externally of said grill, said latch actuators communicating with said left and right latch arms, respectively, and movable for causing said engagement of and disengagement from said left and right hooks, respectively.

20. The barbeque grill of claim 19 further comprising left and right links connecting said grate to said firebox and left and right pivotable connections of said grate to said lid at said left and right hooks, respectively, said left and right links and said left and right pivotable connections cooperating, respectively, to cause said grate to maintain a substantially horizontal disposition during movement between said cooking and loading positions.
